(19) United States
(12) Patent Application Publication
(10) Pub. No.: US 2020/0291947 A1
(43) Pub. Date: Sep. 17, 2020

(54) VEHICLE FLUID PUMP

(71) Applicant: PIERBURG PUMP TECHNOLOGY GMBH, NEUSS (DE)

(72) Inventors: REINHARD GOOTZ, MONHEIM AM RHEIN (DE); STEPHAN RIEFERS, KREFELD (DE); PREDRAG STEVANOVIC, MEERBUSCH (DE); ERCAN BIRINCI, NEUSS (DE); ALEXANDER FINDEISEN, DOEBELN (DE)

(73) Assignee: PIERBURG PUMP TECHNOLOGY GMBH, NEUSS (DE)

(21) Appl. No.: 16/765,478

(22) PCT Filed: Nov. 22, 2017
(86) PCT No.: PCT/EP2017/080055

§ 371 Date: May 20, 2020

(51) Int. Cl. F04D 13/06; H02K 5/22; H02K 11/40; H02K 7/14; H02K 21/14; H02K 5/128

(52) U.S. Cl. CPC F04D 13/064; H02K 5/225; H02K 5/128; H02K 7/14; H02K 21/145; H02K 11/40

(57) ABSTRACT

An electronic motor vehicle fluid pump includes a pump housing and a motor which is electronically commutated. The motor includes a motor rotor which is permanently magnetized, a motor stator with a stator body and a plurality of stator coils, a cylindrical metal motor can which fluidically separates the motor stator and the motor rotor, and a motor electronics unit with an electric ground terminal. The motor electronics unit is arranged at a dry side of the cylindrical metal motor can and is electrically connected to the plurality of stator coils so as to energize the plurality of stator coils to drive the motor rotor. A pump wheel is arranged to co-rotate with the motor rotor. An electric connection provides a direct electric connection between a motor electronics unit ground terminal and the cylindrical metal motor can

The invention is directed to a vehicle fluid pump, in particular to a fluid pump provided with an electronically commutated canned motor.

These vehicle fluid pumps are provided with an electronically commutated motor arranged within a pump housing for driving a pump wheel co-rotatably provided with a motor rotor. Vehicle fluid pumps can be, for example, used as coolant pumps or as lubricant pumps. The pump motor comprises a motor stator with a stator body, preferably a laminated stator body, and with a plurality of stator coils. The pump motor also comprises a permanently magnetized motor rotor and is provided with a motor electronics unit with an electric ground terminal. The motor electronics unit is electrically connected to the stator coils for energizing the stator coils and thereby driving the motor rotor and the co-rotatably provided pump wheel.

The motor stator and the motor rotor are fluidically separated by a cylindrical motor can. As a result, the permanently magnetized motor rotor can be arranged within the fluidic part of the pump and can be easily attached to the pump wheel. The electromagnetic stator with the energized stator coils and the motor electronics unit can be arranged on the dry side of the motor can. No dynamic sealings are needed.

Like all other electronic devices, electronically commutated motors emit electromagnetic interferences, in particular electromagnetic radiation, which can cause malfunction or failure of electronic devices in vicinity of the motor, for example vehicle traction motor electronics. As a consequence, electronic devices have to comply with electromagnetic compatibility (EMC) directives.

It is an object of the present invention to provide a vehicle fluid pump with an electronically commutated canned motor with good EMC-characteristics of the pump.

This object is achieved with a vehicle fluid pump with the features of claim 1.

The vehicle fluid pump according to the invention is provided with a pump housing, an electronically commutated motor, and with a pump wheel which is co-rotatably provided with a motor rotor. Electronically commutated motors provide a high power to weight ratio, high rotational speeds and can be provided with an electronic closed-loop control. This allows providing a very compact vehicle pump which can be easily integrated into the vehicle electrical control system. Preferably, the vehicle pump is supplied with low DC supply voltages of less than 50 V.

The electronically commutated motor of the vehicle fluid pump according to the invention is provided with a motor stator comprising a stator body and a plurality of stator coils. The motor is also provided with a permanently magnetized motor rotor fluidically separated from the motor stator by a cylindrical metal motor can. The electromagnetic motor stator with the energized stator coils is arranged at the dry side of the motor can, and the permanently magnetized motor rotor is arranged at the wet side of the motor can. The generated stator magnetic field penetrates and travels through the metal motor can and drives the permanently magnetized motor rotor and, as a result, drives the pump wheel co-rotatably provided with the motor rotor. This allows a simple co-rotatable connection of the motor rotor and the pump wheel within the fluidic part of the pump, and also allows protecting the electrically energized stator coils and the electronics from being in contact with the pumping fluid.

The electronically commutated motor of the vehicle fluid pump according to the invention is also provided with a motor electronics unit with an electric ground terminal. The motor electronics unit is located at the dry side of the metal motor can to protect the sensitive motor electronics from being in contact with the pumping fluid. The motor electronics unit is electrically connected to the stator coils for energizing the stator coils for driving the motor rotor. The motor electronics unit comprises several power semiconductors for commutating the electric energy energizing the stator coils.

The electronically commutated motor of the vehicle fluid pump according to the invention is also provided with an electric connection means providing a direct electric connection of minimal electric resistance between the motor electronics unit ground terminal and the metal motor can. The direct electric connection provides an equipotential bonding between the metal motor can and the motor electronics. As a result, the metal motor can serves as an electromagnetic shielding significantly suppressing the emitted interferences of the electronically commutated pump motor so that the EMC of the vehicle pump can be dramatically improved.

Preferably, the pump housing is made of plastic. Plastics housings can be manufactured inexpensively, for example by injection molding, and are lightweight. As a result, the plastic housing allows reducing cost and weight of the vehicle pump. However, a plastic housing has no electric shielding effect.

In a preferred embodiment of the invention, the metal motor can is provided as a cylindrical metal tube. A cylindrical metal tube can be easily introduced in the cylindrical air gap between the motor stator and the motor rotor to fluidically separate both. The metal tube can be supported by the pump housing and can be fluid-tightly sealed by a bottom cap to fluidically separate the motor stator from the motor rotor.

Alternatively, the metal motor can can be provided as a cylindrical metal pot which can be easily introduced into the stator rotor air gap, the metal pot being supported by the pump housing and fluidically separating the motor rotor from the motor stator.

Preferably, the cylindrical metal pot providing the motor can is electrically contacted by the electric connection means at the center of the circular metal pot bottom. The electric connection means provides an electrical connection between the motor can and the ground terminal of the motor electronics unit so that the electric potentials are equalized. The motor electronics unit is preferably arranged close to the metal pot bottom. As a result, contacting the center of the circular metal pot bottom allows the electric connection means to be very short so that the EMC is excellent.

Alternatively, the electric connection means can be in electrical contact with the outside circumferential surface of the cylindrical metal motor can. This allows contacting metal motor cans with a non-conductive motor can bottom, for example a metal tube with a plastic cap.

In a preferred embodiment of the invention, the motor electronics unit is arranged at a thermally conductive axial end part of the motor can. The end part can be, for example, provided by a metal pot bottom. The electronics unit is electrically isolated from and thermally connected to the motor can by a thermal compound. The thermal compound allows a heat transfer between the motor electronics and the metal motor can to efficiently dissipate the heat which is generated by the motor electronics unit.

Preferably, the electric connection means is provided as a metal spring attached to the motor electronics unit ground terminal and being in electrical contact with the metal motor can. The metal spring provides a simple and reliable electrical contact. The metal spring allows to compensate oscillations of the motor can with respect to the motor electronics unit and allows a simple mounting process.

In a preferred embodiment of the invention, the electric connection means is directly electrically connected with the ferromagnetic motor stator body so that the electric potential of the motor electronics unit electric ground connection and of the stator body are equalized. This allows good EMC-characteristics of the vehicle pump.

An embodiment of the invention is described with reference to the accompanying drawings, wherein

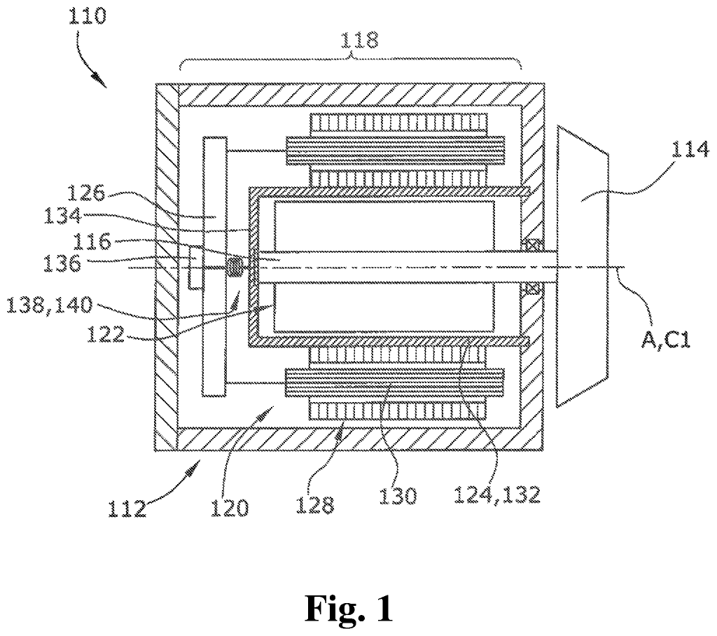

FIG. 1 shows a schematic longitudinal section of a vehicle fluid pump according to the invention,

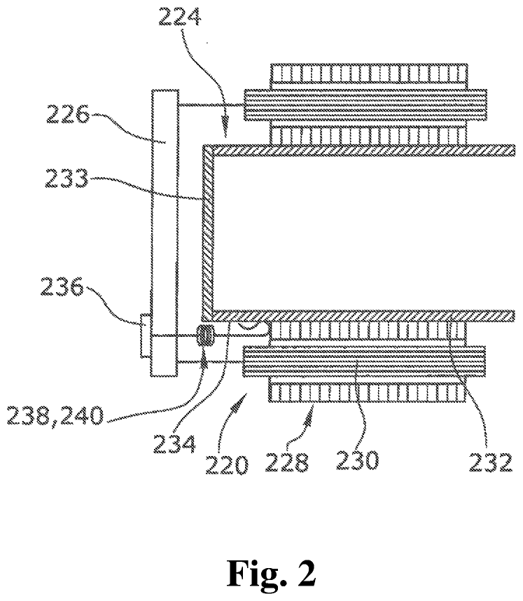

FIG. 2 shows an alternative motor can and an alternative connection means of the vehicle fluid pump of FIG. 1, and

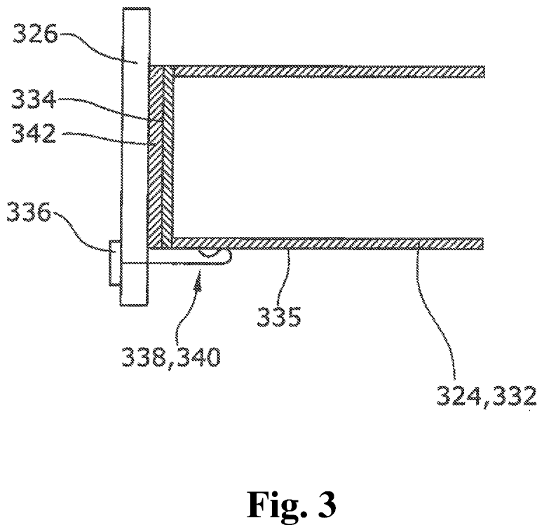

FIG. 3 shows an alternative arrangement of a motor control unit and another alternative connection means of the vehicle fluid pump of FIG. 1.

FIG. 1 shows a schematic longitudinal section of a vehicle fluid pump 110 with a plastic pump housing 112, a pump wheel 114 co-rotatably attached to a rotor shaft 116 of an electronically commutated motor 118. The pump wheel 114 is an impeller. The electronically commutated motor 118 is provided with a motor stator 120, a permanently magnetized motor rotor 122 co-rotatably provided with the rotor shaft 116 and rotatable around an axis of rotation A, a cylindrical metal motor can 124 and a motor electronics unit 126.

The motor stator 120 comprises a ferromagnetic stator body 128, preferably a laminated stator body 128, and comprises several stator coils 130 electrically connected to the motor electronics unit 126.

The cylindrical metal motor can 124 is provided as a cylindrical metal pot 132 axially supported by the pump housing 112. The axial cylinder centerline C1 of the motor can 124 corresponds to the axis of rotation A. The motor can 124 fluidically separates the motor stator 120 arranged at the dry radial outside of the motor can 124 from the motor rotor 122 arranged at the wet radial inside of the motor can 124.

The motor electronics unit 126 is arranged axially outwardly of and close to the motor can bottom 134 at the dry side of the motor can 124. The motor electronics unit 126 commutates the electric energy energizing the stator coils 130 for driving the motor rotor 122 and, as a result, for driving the co-rotatably provided pump wheel 114. The motor electronics unit 126 comprises an electric ground terminal 136 which is directly electrically connected to the motor can 124 by an electric connection means 138. The electric ground terminal 136 can be, for example, provided as a printed circuit path electrically connected to the chassis ground of the vehicle pump 110.

The electric connection means 138 is provided as a metal coil spring 140 fixed, for example soldered, to the motor electronics unit electric ground terminal 136 and being in touching electric contact with the center of the motor can bottom 134. The metal coil spring 140 is preloaded in axial direction to compensate axial oscillations of the motor electronics unit 126 with respect to the motor can 124 and, as a result, to assure a reliable electric connection. The electric connection means 138 equalizes the electric potentials of the motor electronics unit electric ground terminal 136 and of the motor can 124 so that the emitted interferences of the electronically commutated motor 118 are suppressed significantly. As a result, the EMC of the vehicle fluid pump 110 is improved.

FIG. 2 shows a motor stator 220 with a stator body 228 and with several stator coil 230, a motor control unit 226 with an electric ground terminal 236, an alternative motor can 224 and an alternative connection means 238 of the vehicle fluid pump 110.

The motor can 224 comprises a cylindrical metal tube 232 axially supported by the pump housing 212, and comprises a circular non-metallic motor can cap 233 fluid-tightly attached to the non-supported axial end of the metal tube 232.

The motor electronics unit 226 is arranged axially outwardly of the motor can 224 and close to the non-metallic motor can cap 233 at the dry side of the motor can 224. The motor electronics unit electric ground terminal 236 is directly electrically connected to the motor can 224 and to the stator body 228 by an electric connection means 238 provided as metal spring 240.

The metal spring 240 is fixed to the motor electronics unit electric ground terminal 236. The metal spring 240 is radially in contact with a circumferential surface 234 of the motor can 224 and axially in contact with the stator body 228. The metal spring 240 is preloaded in axial direction to compensate axial oscillations of the motor electronics unit 226 with respect to the stator body 228. The metal spring 240 is also preloaded in radial direction, in particular radially inwardly, to compensate radial oscillations of the motor electronics unit 226 with respect to the motor can 224.

The electric connection means 238 assures a reliable electric connection between the motor electronics unit electric ground terminal 236, the motor can 224 and the stator body 228 so that the electric potentials are equalized. As a result, emitted interferences of the electronically commutated motor 218 can be minimized and the EMC of the vehicle fluid pump 210 can be improved.

FIG. 3 shows a motor can 324 provided as a cylindrical metal pot 332, a motor control unit 326 with an electric ground terminal 336 and another alternative connection means 338 of the vehicle fluid pump 110.

The motor electronics unit 326 is arranged axially outwardly at the motor can bottom 334 at the dry side of the motor can 324. The motor electronics unit 326 is electrically isolated from and thermally connected with the motor can 324 by a thermal compound 342. The thermal compound 342 allows a heat transfer from the motor electronics unit 326 to the motor can 324 to efficiently dissipate heat generated in the motor electronics unit 326.

The motor electronics unit electric ground terminal 336 is directly electrically connected to the motor can 324 by an electric connection means 338 provided as metal leaf spring 340. The metal leaf spring 340 is fixed to the motor electronics unit electric ground terminal 336 and is in touching electric contact with the circumferential surface 335 of the motor can 324. The metal leaf spring 340 is preloaded in radial direction, in particular radially inwardly, to compensate radial oscillations of the motor electronics unit 326 with respect to the motor can 324. The electric connection means 338 assures a reliable electric connection between the motor electronics unit electric ground terminal 336 and the motor can 324 to equalize the electric potentials and, as a result, to improve the EMC of the vehicle fluid pump 310.

### REFERENCE LIST

110 vehicle fluid pump
112 plastic pump housing
114 pump wheel
116 rotor shaft
118 electronically commutated motor
120 motor stator
122 permanently magnetized motor rotor
124 cylindrical metal motor can
126 motor electronics unit
128 stator body
130 stator coils
132 cylindrical metal pot
134 motor can bottom
136 electric ground terminal
138 electric connection means
140 metal coil spring
220 motor stator
224 metal motor can
226 motor electronics unit
228 stator body
230 stator coils
232 metal tube
233 non-metallic motor can cap
236 electric ground terminal
238 electric connection means
240 metal spring
324 metal motor can
326 motor electronics unit
332 metal pot
334 motor can bottom
335 motor can circumferential surface
336 electric ground terminal
338 electric connection means
340 metal leaf spring
342 thermal compound
A axis of rotation
C1 cylinder centerline
C2 cylinder centerline

1-9. (canceled)

10: An electronic motor vehicle fluid pump comprising:
a pump housing;
a motor which is electronically commutated, the motor comprising,
a motor rotor which is permanently magnetized,
a motor stator comprising a stator body and a plurality of stator coils,
a cylindrical metal motor can which is configured to fluidically separate the motor stator and the motor rotor, and
a motor electronics unit comprising an electric ground terminal, the motor electronics unit being arranged at a dry side of the cylindrical metal motor can and being electrically connected to the plurality of stator coils so as to energize the plurality of stator coils to drive the motor rotor;
a pump wheel which is arranged to co-rotate with the motor rotor;
a motor electronics unit ground terminal; and
an electric connection is configured to provide a direct electric connection between the motor electronics unit ground terminal and the cylindrical metal motor can.

11: The electronic motor vehicle fluid pump as recited in claim 10, wherein the pump housing is made of a plastic.

12: The electronic motor vehicle fluid pump as recited in claim 10, wherein the cylindrical metal motor can is provided as a cylindrical metal tube.

13: The electronic motor vehicle fluid pump as recited in claim 10, wherein the cylindrical metal motor can is provided as a cylindrical metal pot.

14: The electronic motor vehicle fluid pump as recited in claim 13, further comprising:
a circular metal pot comprising a bottom which comprises a center,
wherein,
the electric connection is further configured to be in electrical contact with the center of the bottom of the circular metal pot.

15: The electronic motor vehicle fluid pump as recited in claim 13, further comprising:
a thermal compound,
wherein,
the cylindrical metal motor can comprises an axial end, and
the motor electronics unit is arranged at the axial end of the cylindrical metal motor can so as to be electrically isolated from and thermally connected to the cylindrical metal motor can via the thermal compound.

16: The electronic motor vehicle fluid pump as recited in claim 10, wherein,
the cylindrical metal motor can comprises a circumferential surface, and
the electric connection is in electrical contact with the circumferential surface of the cylindrical metal motor can.

17: The electronic motor vehicle fluid pump as recited in claim 10, wherein the electric connection is provided as a metal spring which is fixed to the motor electronics unit ground terminal and which is in electrical contact with the cylindrical metal motor can.

18: The electronic motor vehicle fluid pump as recited in claim 10, wherein the electric connection is further electrically connected with the stator body.
